(19) United States
(12) Patent Application Publication
(10) Pub. No.: US 2026/0348412 A1
(43) Pub. Date: Nov. 5, 2026

(54) FLOATING STRUCTURE

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 19/393,628

(22) Filed: Nov. 19, 2025

(30) Foreign Application Priority Data
May 5, 2025 (TW) 114116795

(51) Int. Cl. F16B 5/02

(52) U.S. Cl. CPC F16B 5/0225

(57) ABSTRACT

A floating structure is disclosed. The floating structure includes a main body and a floating section; and the floating section is movably mounted on the main body. Through cooperation of the main body with the floating section, it is able to achieve the objective of moving the floating structure more smoothly to abut it against an object and hold it in place on the object.

### CROSS-REFERENCE TO RELATED APPLICATION

This non-provisional application claims priority under 35 U.S.C. § 119(a) on Patent Application No(s). 114116795 filed in Taiwan, R.O.C. on May 5, 2025, the entire contents of which are hereby incorporated by reference.

### BACKGROUND OF THE INVENTION

### Field of the Invention

The present disclosure relates to a floating structure, and in particular to a floating structure that can be smoothly moved to abut against an object and be held in place on the object.

### Description of the Related Art

Generally, when a work piece is to be moved to abut against an object and be held in place on the object but there is not any corresponding structure designed for achieving such moving or abutting, the work piece would not be movable smoothly to abut against the object and be held in place on the object.

### BRIEF SUMMARY OF THE INVENTION

An objective of the present disclosure is to provide a floating structure to overcome the problem in the prior art. With the floating structure of the present invention, it is able to achieve the objective of moving a work piece more smoothly to abut the work piece against an object and hold it in place on the object.

To achieve at least the above objective, the floating structure according to the present disclosure includes a main body and a floating section; and the floating section is movably mounted on the main body.

In an embodiment of the floating structure, the main body consists of a first body portion and a second body portion, and the first and the second body portion together limit the floating section to a position between the first and the second body portion.

In an embodiment of the floating structure, the first body portion or the second body portion is provided with an alignment section. Before the first and the second body portion are assembled or riveted to each other, they are aligned with each other or limited to a position via the alignment section.

In an embodiment of the floating structure, a longitudinally extended first floating amount is existed between the floating section and the first body portion; or a longitudinally extended second floating amount is existed between the floating section and the first or the second body portion; or a transversely extended third floating amount is existed between the floating section and the first body portion; or a transversely extended fourth floating amount is existed between the floating section and the second body portion; or a longitudinally extended fifth floating amount is existed between the floating section and the second body portion.

In an embodiment of the floating structure, the first or the second body portion is provided with a coupling section, which is a clinching section or a toothed section. The first or the second body portion can be clinched to assemble with the other one, so that a partial material of the first or the second body portion is forced or flows into a clinching space provided by the clinching section to thereby connect the two body portions to each other.

In an embodiment of the floating structure, at least one longitudinal or transverse floating amount is existed between the main body and the floating section.

In an embodiment of the floating structure, the main body consists of a first body portion and a second body portion; one of the first and the second body portion is provided with a coupling section, and the first and the second body portion are connected to each other via the coupling section. The floating section is limited to a position between the first and the second body portion. The coupling section can be a riveting section, a protruded section, or a recessed section. The first and the second body portion can be riveted to each other to limit the floating section to a position between them. In another embodiment, the floating structure further includes an intermediate member, which is disposed between the main body and the floating section; or an intermediate member is disposed between the main body and the floating section for limiting the floating section to a fixed position. In another embodiment, the first or the second body portion includes a connection section, and the connection section on the first or the second body portion can be an externally threaded section, an internally threaded section, a riveting section, an expansion connection section, a locking section, a welding section, a snap joint, or an elastic fastening section. In an embodiment, one of the first and the second body portion is provided with a handling section, which is used to assemble or lock the main body to an object.

In an embodiment of the floating structure, the main body consists of a first body portion and a second body portion. In an embodiment, one of the first and the second body portion is provided with a coupling section, and the first and the second body portion are connected to each other via the coupling section. The floating section is limited to a position between the first and the second body portion. The coupling section can be a riveting section, a protruded section, or a recessed section. The first and the second body portion can be riveted to each other to limit the floating section to a position between them. In an embodiment, the floating structure further includes an intermediate member, which is disposed between the main body and the floating section. Or, an intermediate member is disposed between the main body and the floating section to limit the floating section to a position. In another embodiment, the first or the second body portion includes a connection section. The connection section on the first or the second body portion can be an externally threaded section, an internally threaded section, a riveting section, an expansion connection section, a locking section, a welding section, a snap joint, or an elastic fastening section. In an embodiment, one of the first and the second body portion is provided with a handling section, which is used to assemble or lock the main body to an object.

In an embodiment of the floating structure, the handling section can be a cross-shaped section, a straight line-shaped section, a hexagon-shaped section, a polygon-shaped section, a star-shaped section, a protruded section, or a recessed section.

In an embodiment of the floating structure, the main body consists of a first body portion and a second body portion. In another embodiment, one of the first body portion and the second body portion is provided with a connection section; and the connection section is extended through an object to connect to a receiving section.

In an embodiment of the floating structure, the floating section is provided with a coupling section. The second body portion of the main body is assembled to the coupling section on the floating section after the first body portion of the main body is connected to the floating section, and another second body portion of the main body is further connected to a coupling section provided on the first body portion, so as to hold the first body portion in place.

In an embodiment of the floating structure, the floating section is provided with a coupling section. After a first body portion is connected to the floating section, a second body portion is connected to the coupling section on the floating section to limit the first body portion to the floating section.

In an embodiment of the floating structure, the main body consists of a first body portion and a second body portion; and a substance or an intermediate material capable of reducing frictional force is provided between the floating section and the first body portion and/or the second body portion. In another embodiment, the first body portion, the second body portion, and/or the floating section are respectively provided with a substance or an intermediate material capable of reducing frictional force. The substance or the intermediate material capable of reducing frictional force can be grease, a Teflon layer, a liquid, a solid, or a coating.

In an embodiment of the floating structure, the main body or the floating section is provided on at least one end with a connection section. The connection section can be locked, riveted, snap-fitted, expansion connected, or welded to at least one object. And, the floating section is in the shape of a shaft or a column.

In the above embodiment, the connection section of the floating structure can be an externally threaded section, an internally threaded section, a column, a riveting section, an expansion connection section, a welding section, an elastic fastening section, and a snap-fit joint.

In an embodiment of the floating structure, the floating section is configured to be transversely movable into a movement position on another object, so as to be engaged with or be limited to the other object.

In an embodiment, the floating structure further includes an elastic element and the main body consists of a first body portion and a second body portion. The elastic element has an end pressed against the floating section and another end pressed against the first or the second body portion.

In an embodiment, the floating structure further includes an elastic element, and the main body consists of a first body portion and a second body portion. The elastic element has an end pressed against the floating section and another end pressed against the first or the second body portion, so that the floating section is elastically moved into a movement position on another object to engage with, press against, elastically press against, or limit the other object.

In an embodiment of the floating structure, the floating section includes an elevating section for abutting against or elevating another object. The elevating section is a slant surface.

In an embodiment of the floating structure, the main body consists of a first body portion and a second body portion. The first body portion includes a retaining section and a handling section, and the second body portion has a height larger than that of the first body portion to form a protection zone. In an embodiment, the floating section serves as a third body portion, or a floating amount is existed between the third body portion and the first body portion.

In an embodiment of the floating structure, the main body is a first body portion, which is provided with a retaining section and a handling section. A second body portion has a height larger than that of the first body portion to form a protection zone. In an embodiment, the floating section serves as the second body portion, or a floating amount is existed between the first and the second body portion.

In an embodiment of the floating structure, the main body consists of a first and a second body portion; and the first body portion includes a retaining section and a handling section. The second body portion has a height larger than that of the first body portion to form a protection zone. The second body portion can limit, transversely block, stop, or embank a tool operating or being used to operate the handling section or prevent the tool in use or in operating the handling section from extending out of the protection zone to undesirably collide with or damage any peripheral element. The peripheral element can be a chip, a printed circuit board, a connector, an optical fiber, a capacitor, a resistor, an electronic element, a heat sink, or an electrically conductive member. In an embodiment, the floating section serves as a second body portion, or in another embodiment, a floating amount is existed between the first body portion and the second body portion. Or, the main body serves as a first body portion having a retaining section and a handling section, and a second body portion has a height larger than that of the first body portion to form a protection zone. The second body portion can limit, transversely block, stop, or embank a tool operating or being used to operate the handling section or can prevent the tool in use or in operating the handling section from extending out of the protection zone to undesirably collide with or damage any peripheral element. The peripheral element can be a chip, a printed circuit board, a connector, an optical fiber, a capacitor, a resistor, an electronic element, a heat sink, or an electrically conductive member. In this embodiment, the floating section serves as the second body portion, or a floating amount is existed between the first body portion and the second body portion.

In an embodiment of the floating structure, the handling section can be a straight line-shaped section, a cross-shaped section, a star-shaped section, or a hexagon-shaped section; or the handling section can be operated with a tool, or the tool is a screwdriver or a rotatable operating member.

In an embodiment of the floating structure, the first body portion and the second body portion are movably assembled with a third body portion or an elastic element, and the third body portion is used to connect to an object to be connected.

In an embodiment of the floating structure, the first body portion, the second body portion, or the third body portion can define an accommodation space for accommodating the elastic element therein.

In an embodiment of the floating structure, the second body portion is formed in a way of plastic injection molding, plastic insert molding, spray painting, baking finish, coating, or electroplating, such that the second body portion includes a colored layer to allow for recognition of the second body portion by color. In an embodiment, the second body portion is formed by plastic injection molding or plastic insert molding. In an embodiment, the second body portion is formed by plastic injection molding or plastic insert molding to be coupled to or assembled with the first body portion.

In an embodiment of the floating structure, the protection zone can be used to limit, block, or embank a tool when the tool is used to operate the handling section, lest the tool should be extended out of the protection zone to collide with or damage the periphery element or transversely stopping or limiting the tool from moving transversely.

In an embodiment of the floating structure, a sixth floating amount is existed between the main body and an object or an object to be connected; a seventh floating amount is existed between the main body and the floating section; and the sixth and the seventh floating amount can be used to adjust the position of the floating section.

In an embodiment of the floating structure, the main body is provided with a retaining section; the retaining section is used to retain an object or to extend through an object to retain an object to be connected.

In an embodiment of the floating structure, the retaining section can be an externally threaded section, an internally threaded section, a column, a male retaining section, a female retaining section, or an elastic fastening member.

In an embodiment of the floating structure, the main body is connected with a connection section, and an eighth floating amount is existed between the main body and the connection section.

In an embodiment, the floating structure further includes a covering member, and the covering member is connected to or snap-fitted onto the floating section.

In an embodiment of the floating structure, the covering member includes an engagement section; and the covering member is engaged with or snap-fitted onto the floating section via the engagement section.

In an embodiment of the floating structure, a ninth floating amount is existed between the covering member and the main body, and the floating section can be used to adjust the ninth floating amount.

In an embodiment of the floating structure, the floating section includes a receiving section; the receiving section is used to receive a limiting section so as to limit the main body to a position; or the limiting section is an element with elasticity to be elastically snap-fitted into the receiving section.

In an embodiment of the floating structure, the floating section includes an engagement section; the engagement section is used to engage with a covering member; or the engagement section is snap-fitted, locked, riveted, expansion connected, or welded to the covering member. In an embodiment, the engagement section can be an internally threaded section, an externally threaded section, a male retaining section, a female retaining section, a female snap joint, an elastic snap-fit joint, or a column.

In an embodiment of the floating structure, the floating section includes an anti-rotation section, which is used to prevent the main body from rotating.

In an embodiment, the floating structure further includes an elastic element, which has two ends separately pressed against the main body and the floating section, so that the floating section is elastically floatable or correctable relative to the main body, preventing the floating section form being located eccentrically or elastically floating eccentrically.

In an embodiment, the floating structure can be a wheel, a rotary member, a fastening element, a handle, or a puller; or a fastener mounted on a heat sink, a fastener mounted on a server or a computer, a fastener mounted on a printed circuit board, a fastener mounted on a metal member, or a fastener mounted on a plastic member; a wheel mounted on a heat sink, a wheel mounted on a server or a computer, a wheel mounted on a printed circuit board, a wheel mounted on a metal member, or a wheel mounted on a plastic member; or a handle or a puller mounted on a heat sink, a handle or a puller mounted on a server or a computer, a handle or a puller mounted on a printed circuit board, a handle or a puller mounted on a metal member, or a handle or a puller mounted on a plastic member.

The present disclosure also provides a method of using a floating structure. The floating structure includes a main body and a floating section, and the floating section is movably mounted on the main body. The main body consists of a first body portion and a second body portion. The first body portion or the second body portion is provided with a coupling section, and the first and the second body portion are connected to each other via the coupling section. The floating section is limited to a position between the first and the second body portion. The coupling section can be a riveting section, a protruded section, or a recessed section, and the first and the second body portion can be riveted to each other to limit the floating section to a fixed position. An intermediate member may be provided and disposed between the main body and the floating section. In an embodiment, the intermediate member is disposed between the main body and the floating section to limit the floating section to a fixed position. One of the first and the second body portion can be provided with a connection section; and the connection section on the first or the second body portion can be an externally threaded section, an internally threaded section, a riveting section, an expansion connection section, a locking section, a welding section, a snap joint, or an elastic fastening section. Or one of the first and the second body portion is provided with a handling section, which is used to assemble or lock the main body to an object. In an embodiment, the main body consists of a first and a second body portion. The first or the second body portion is provided with a coupling section, and the first and the second body portion are connected to each other via the coupling section. The floating section is limited to a position between the first and the second body portion. The coupling section can be a riveting section, a protruded section, or a recessed section. The first and the second body portion can be riveted to each other to limit the floating section to a position between them. An intermediate member can be provided and disposed between the main body and the floating section. The intermediate member is disposed between the main body and the floating section to limit the floating section to a fixed position. Or one of the first and the second body portion is provided with a connection section, and the connection section on the first or the second body portion can be an externally threaded section, an internally threaded section, a riveting section, an expansion connection section, a locking section, a welding section, a snap joint, or an elastic fastening section. Or, one of the first and the second body portion is provided with a handling section, which is used to assemble or lock the main body to an object.

The present disclosure also provides another method of using a floating structure. The floating structure includes a main body and a floating section movably mounted on the main body. The main body consists of a first body portion and a second body portion. The first body portion includes a retaining section and a handling section. The second body portion has a height larger than that of the first body portion to form a protection zone. The second body portion limits, transversely blocks, stops, or embanks a tool operating or being used to operate the handling section or prevents the tool in use or in operating the handling section from extending out of the protection zone to undesirably collide with or damage any peripheral element. The peripheral element can be a chip, a printed circuit board, a connector, an optical fiber, a capacitor, a resistor, an electronic element, a heat sink, or an electrically conductive member.

The present disclosure also provides a further method of using a floating structure. The floating structure includes a main body and a floating section movably mounted on the main body. The main body consists of a first body portion and a second body portion. A longitudinally extended first floating amount is existed between the floating section and the first body portion, or a longitudinally extended second floating amount is existed between the floating section and the first or the second body portion, or a transversely extended third floating amount is existed between the floating section and the first body portion, or a transversely extended fourth floating amount is existed between the floating section and the second body portion, or a longitudinally extended fifth floating amount is existed between the floating section and the second body portion. In an embodiment, the first or the second body portion is provided with a coupling section. The coupling section can be a clinching section or a toothed section. The first body portion or the second body portion can be clinched at the coupling section to be connected to each other, so that a partial material of the first body portion or the second body portion is forced or flows into a clinching space provided by the clinching section to connect the first and the second body portion to each other.

With the above described structure, the floating structure of the present disclosure can be moved more smoothly to abut against an object to be held in place on the object.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded side view of a floating structure according to a first embodiment of the present disclosure.

FIG. 2 is an assembled side view of the floating structure of FIG. 1.

FIG. 3 shows different designs possible for a connection section of the floating structure according to the present disclosure.

FIG. 4 shows different designs possible for a handling section of the floating structure according to the present disclosure.

FIG. 5 is an exploded side view of a floating structure according to a second embodiment of the present disclosure.

FIG. 6 is an assembled side view of the floating structure of FIG. 5.

FIG. 7 shows an exploded and an assembled side view of a floating structure according to a third embodiment of the present disclosure.

FIG. 8 shows two top views of the floating structure according to the third embodiment of the present disclosure before and after a second body portion is fully assembled to between a first body portion and a floating section, respectively.

FIG. 9 is an assembled side view of a floating structure according to a fourth embodiment of the present disclosure.

FIG. 10 is an assembled side view of a floating structure according to a fifth embodiment of the present disclosure.

FIG. 11 pictorially shows the manner of assembling a floating structure according to a sixth embodiment of the present disclosure.

FIG. 12 pictorially shows the manner of assembling a floating structure according to a seventh embodiment of the present disclosure.

FIG. 13 pictorially shows the manner of assembling a floating structure according to an eighth embodiment of the present disclosure.

FIG. 14 pictorially shows the manner of assembling a floating structure according to a ninth embodiment of the present disclosure.

FIG. 15 includes two top views for showing the manner of assembling the floating structure according to the ninth embodiment of the present disclosure.

FIG. 16 is an assembled side view of a floating structure according to a tenth embodiment of the present disclosure.

FIG. 17 is an assembled side view showing longitudinal and transversely floating amounts allowable for a floating structure according to an eleventh embodiment of the present disclosure.

FIG. 18 is an assembled side view showing longitudinal and transversely floating amounts allowable for a floating structure according to a twelfth embodiment of the present disclosure.

FIG. 19 is an assembled side view showing longitudinal and transversely floating amounts allowable for a floating structure according to a thirteenth embodiment of the present disclosure.

FIG. 20 pictorially shows the manner of assembling the floating structure according to the thirteenth embodiment of the present disclosure.

FIG. 21 pictorially shows the manner of assembling a floating structure according to a fourteenth embodiment of the present disclosure to two objects.

FIG. 22 is a fragmentary side view of FIG. 21.

FIG. 23 pictorially shows the manner of assembling a floating structure according to a fifteenth embodiment of the present disclosure.

FIG. 24 shows different designs possible for a handling section of the floating structure according to the present disclosure.

FIG. 25 is an assembled side view of a floating structure according to a sixteenth embodiment of the present disclosure.

FIG. 26 is an assembled side view of a floating structure according to a seventeenth embodiment of the present disclosure.

FIG. 27 is an assembled side view of a floating structure according to an eighteenth embodiment of the present disclosure.

FIG. 28 is an assembled side view of a floating structure according to a nineteenth embodiment of the present disclosure.

FIG. 29 pictorially shows the manner of assembling a floating structure according to a twentieth embodiment of the present disclosure to an object and an object to be connected.

FIG. 30 pictorially shows the manner of assembling a floating structure according to a twenty-first embodiment of the present disclosure.

FIG. 31 pictorially shows the manner of assembling a floating structure according to a twenty-second embodiment of the present disclosure.

FIG. 32 shows different designs possible for a retaining section of the floating structure according to the present disclosure.

FIG. 33 is a schematic view showing a floating structure according to a twenty-third embodiment of the present disclosure.

FIG. 34 pictorially shows the manner of assembling a floating structure according to a twenty-fourth embodiment of the present disclosure.

FIG. 35 shows two top views of the floating structure according to the twenty-fourth embodiment of the present disclosure before and after a limiting section thereof is fully set in a receiving section, respectively.

FIG. 36 is an assembled side view showing a floating structure according to a twenty-fifth embodiment of the present disclosure.

FIG. 37 shows different designs possible for an engagement section of the floating structure according to the present disclosure.

### DETAILED DESCRIPTION OF THE INVENTION

To facilitate understanding of the object, characteristics and effects of the present disclosure, embodiments together with the accompanying drawings for the detailed description of the present disclosure are provided.

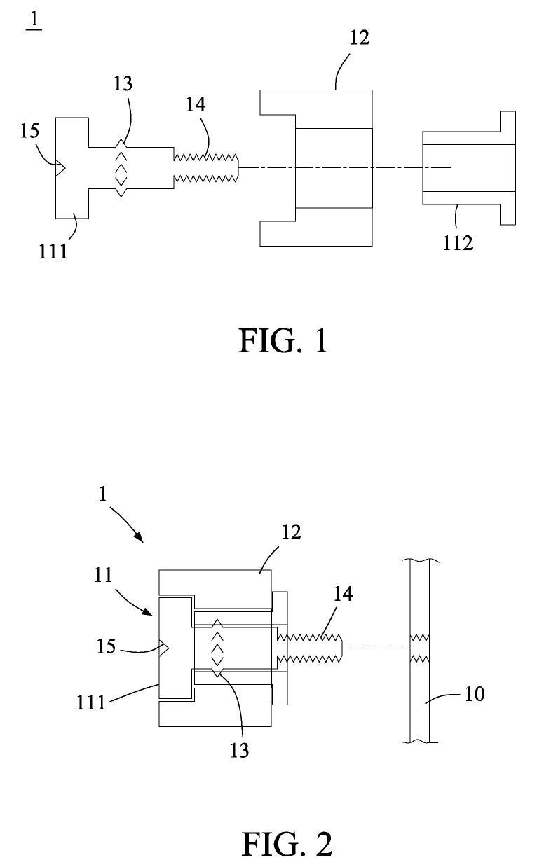

Please refer to FIGS. 1 to 4. As shown, a floating structure 1 according to a first embodiment of the present disclosure includes a main body 11 and a floating section 12.

When using the floating structure 1 of the present disclosure, the main body 11 can be connected to or screwed to an object 10. With the floating section 12 that cooperates with the main body 11, it is able to achieve the objective of moving the floating structure 1 more smoothly to abut it against the object 10 and hold it in place on the object 10.

A floating structure according to a first variant of the first embodiment of the present disclosure is different from the first embodiment in that the main body 11 consists of a first body portion 111 and a second body portion 112, which are used to limit the floating section 12 to a position. The first body portion 111 or the second body portion 112 is provided with a coupling section 13, which can be in the form of a riveting section, a protruded section, or a recessed section, for joining the first body portion 111 and the second body portion 112 to each other, such that the first and the second body portion 111, 112 can be connected by riveting to thereby limit the floating section 12 to a position. In this way, the first and the second body portion 111, 112 can be stably and securely connected to each other via the coupling section 13, and the floating section 12 can be limited to a position between the first body portion 111 and the second body section 112. Therefore, it is able to achieve the objective of moving the floating structure 1 more smoothly to abut it against the object 10 and hold it in place on the object 10.

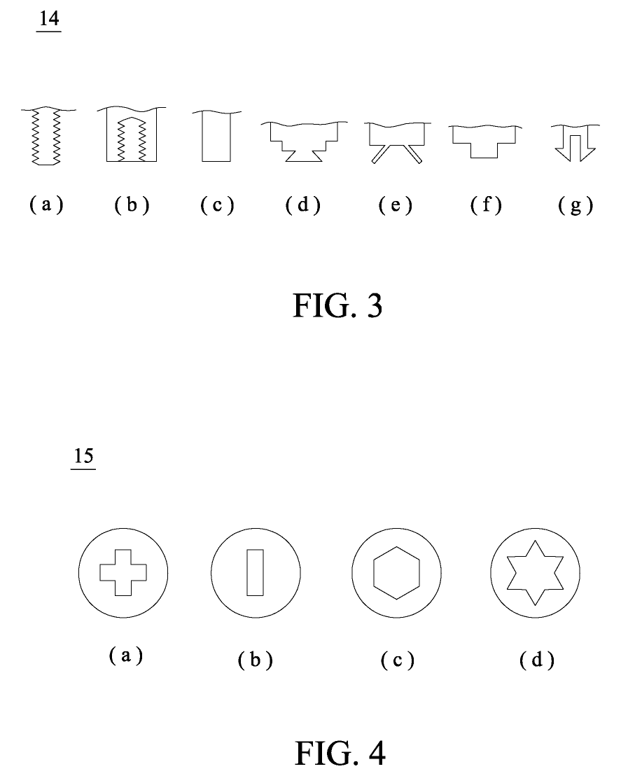

A floating structure according to a second variant of the first embodiment of the present disclosure is different from the first embodiment in that one of the first body portion 111 and the second body portion 112 of the main body 11 or the floating section 12 is provided at one or both ends with a connection section 14. The connection section 14 can be differently designed, such as being provided with male threads or being an externally threaded section, as shown in FIG. 3(a), or being provided with female threads or being an internally threaded section, as shown in FIG. 3(b), or being a column, as shown in FIG. 3(c), or being a riveting section, as shown in FIG. 3(d), or being an expansion connection section, as shown in FIG. 3(e), or being a locking section, or being a welding section, as shown in FIG. 3(f), or being a snap-fit joint or an elastic fastening section, as shown in FIG. 3(g), so that the connection section 14 can be locked, riveted, snap-fitted, expansion connected, or welded to at least one object 10; or alternatively, the floating section 12 can be in the shape of a shaft or a column. With these arrangements, it is able to achieve the objective of moving the floating structure 1 more smoothly to abut it against the object 10 and hold it in place on the object 10.

In addition to the above embodiments, there is a floating structure according to a third variant of the first embodiment. The third variant is different from the first embodiment and the previous variants in that the first or the second body portion 111, 112 of the main body 11 is provided at another end with a handling section 15. A force can be applied to the handling section 15, so as to connect or lock the connection section 14 of the main body 11 to the object 10. In this way, the main body 11 can be stably and securely fixed to the object 10 via the connection section 14. With these arrangements, it is able to achieve the objective of moving the floating structure 1 more smoothly to abut it against the object 10 and hold it in place on the object 10.

In addition to the above embodiments, there is a floating structure according to a fourth variant of the first embodiment. The fourth variant is different from the first embodiment and the previous variants in that the handling section 15 may be a recessed or a protruded section. The recessed or the protruded section may be in the shape of a cross, as shown in FIG. 4(a), or a straight line, as shown in FIG. 4(b), or a hexagon, as shown in FIG. 4(c), or a polygon, as shown in FIG. 4(d), or a star, as shown in FIG. 4(e). In this way, a force can be more easily applied to the handling section 15 to meet the need in operation.

In addition to the above embodiments, there is a floating structure according to a fifth variant of the first embodiment. The fifth variant is different from the first embodiment and the previous variants in that the floating structure 1 may be any one of a wheel, a rotary member, fastening element, a handle, a puller, a fastener mounted on a heat sink, a fastener mounted on a server or a computer, a fastener mounted on a printed circuit board, a fastener mounted on a metal member, or a fastener mounted on a plastic member, a wheel mounted on a heat sink, a wheel mounted on a server or a computer, a wheel mounted on a printed circuit board, a wheel mounted on a metal or a plastic member, a handle or a puller mounted on a heat sink, a handle or a puller mounted on a server or a computer, a handle or a puller mounted on a printed circuit board, a handle or a puller mounted on a metal member, or a handle or a puller mounted on a plastic member.

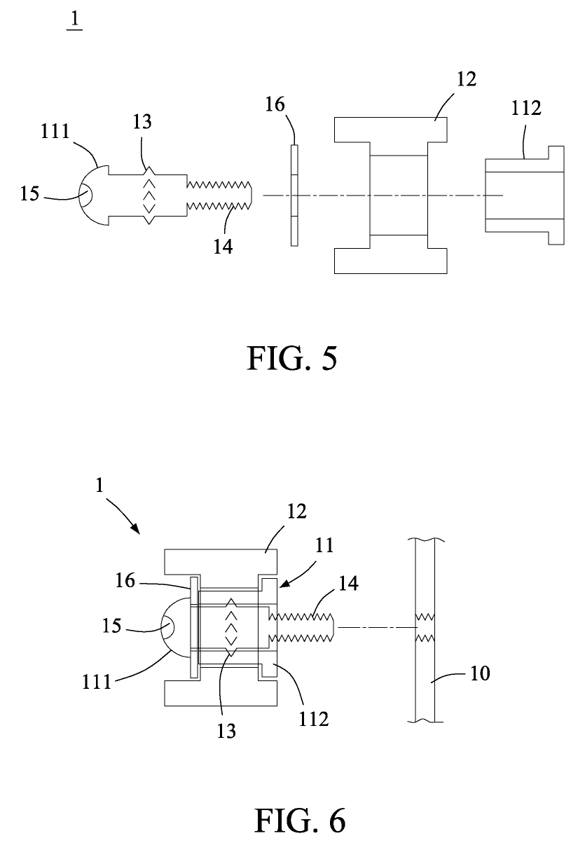

Please refer to FIGS. 5 and 6. As shown, in addition to the first embodiment and the variants thereof, there is a floating structure 1 according to a second embodiment of the present disclosure. The second embodiment is different from the above described embodiment and variants in that the floating structure 1 further includes an intermediate member 16, which is disposed between the main body 11 and the floating section 12 for limiting the floating section 12 to a position. For instance, the intermediate member 16 can be limited to a position between the first body portion 111 and the floating section 12. In this way, the floating structure of the present disclosure can better meet more requirements in practical applications of the present disclosure.

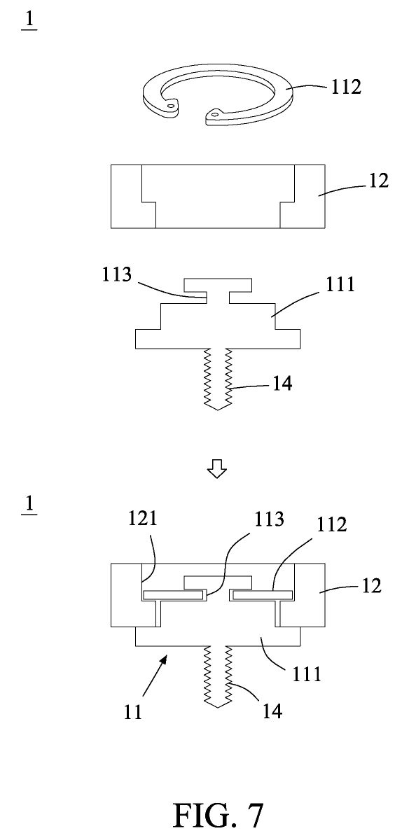

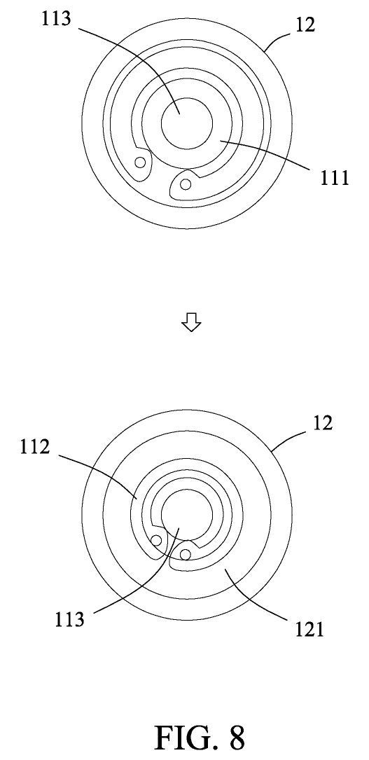

Please refer to FIGS. 7 and 8. As shown, in addition to the first and second embodiments and the variants of the first embodiment, there is a floating structure 1 according to a third embodiment of the present disclosure. The third embodiment is different from the above described embodiments and variants in that the second body portion 112 can be an elastic member, such as a retaining sheet, a washer, or a leaf spring; and the first body portion 111 is provided with a receiving section 113. When assembling the floating structure 1, a first step is to force open or to expand the second body portion 112 to a size larger than the receiving section 113. The second body portion 112 is elastically restored after it passes over the receiving section 113. Meanwhile, a limiting section 121 defined by an inner wall surface of the floating section 12 serves to limit an extent to which the second body portion 112 can be elastically restored, such that the second body portion 112 is retained to the receiving section 113. That is, the first body portion 111 and the second body portion 112 are assembled to each other through engagement of the second body portion 112 with the receiving section 113 on the first body portion 111. In the meantime, the floating section 12 is limited to a position between the first and the second body portion 111, 112. In this way, the first body portion 111 and the second body portion 112 can be retained and assembled to each other, and the floating section 12 is movably limited to a position between the assembled first and second body portions 111, 112. With these arrangements, it is able to achieve the objective of being moved more smoothly to abut against an object and to be held in place on the object.

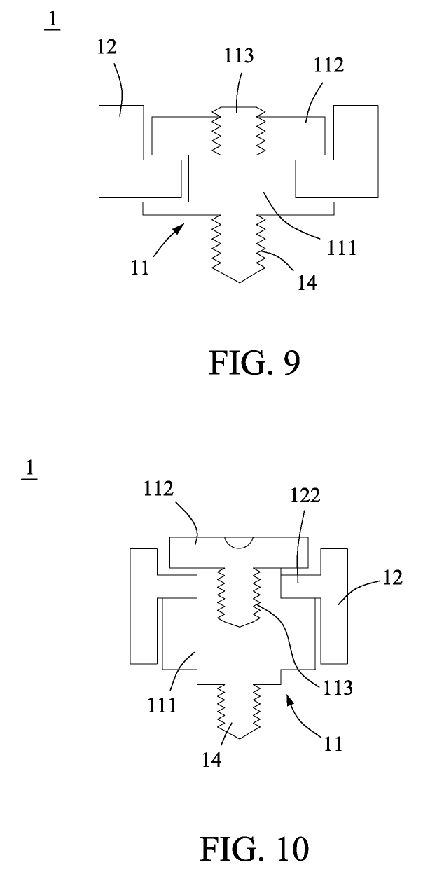

Please refer to FIG. 9. As shown, in addition to the first, the second, and the third embodiments and the variants of the first embodiment, there is a floating structure 1 according to a fourth embodiment of the present disclosure. The fourth embodiment is different from the above described embodiments and variants in that the second body portion 112 is a nut while the receiving section 113 is an externally threaded section, so that the first body portion 111 and the second body portion 112 can be joined by screwing the receiving section 113 to the second body portion 112 to thereby limit the floating section 1 between the first body portion 111 and the second body portion 112. In this way, the first body portion 111 and the second body portion 112 can be screwed to each other and the floating section 12 is movably limited to a position between the first and the second body portion 111, 112. Therefore, it is able to achieve the objective of moving the floating structure 1 more smoothly to abut it against an object and hold it in place on the object.

Please refer to FIG. 10. As shown, in addition to the above described first to fourth embodiments and variants of the first embodiment, there is a floating structure according to a fifth embodiment of the present disclosure. The fifth embodiment is different from the previous embodiments and variants in that the second body portion 112 is in the form of a screw while the receiving section 113 is an internally threaded section, so that the first body portion 111 and the second body portion 112 can be screwed to each other and the floating section 1 is movable limited to a position between the first body portion 111 and the second body portion 112. In this way, the first body portion 111 and the second body portion 112 can be screwed to each other and the floating section 12 is movably limited to a position between the first and the second body portion 111, 112. Therefore, it is able to achieve the objective of moving the floating structure 1 more smoothly to abut it against an object and hold it in place on the object.

In a variant of the fifth embodiment, the floating section 12 of the floating structure 1 further includes a stop section 122. When the first body portion 111 and the second body portion 112 are screwed to each other, the stop section 122 is located between the first body portion 111 and the second body portion 112. In this way, it is able to achieve the objective of moving the floating structure 1 more smoothly to abut it against an object and hold it in place on the object.

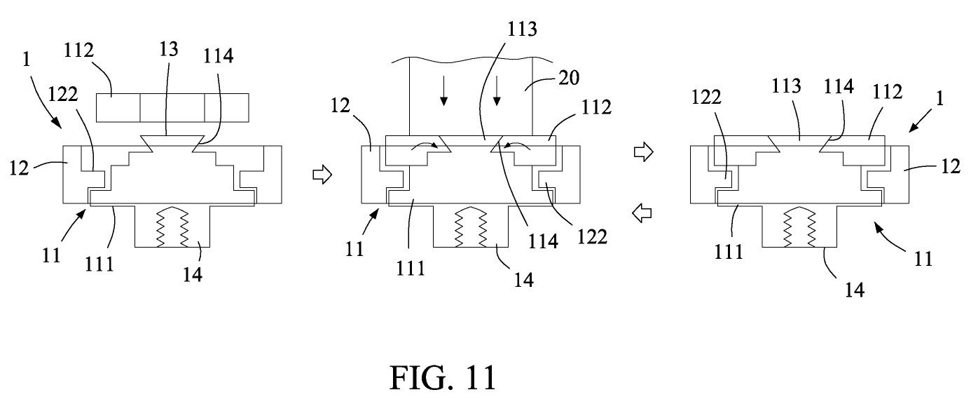

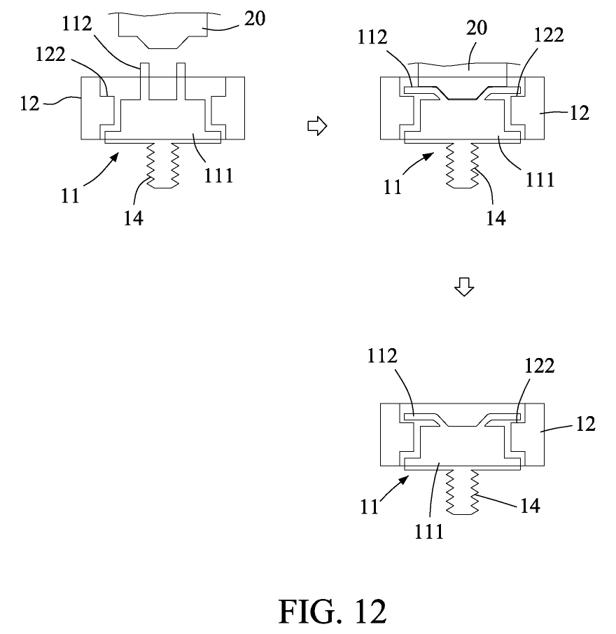

Please refer to FIG. 11. As shown, in addition to the above described first to fifth embodiments and the variants, a floating structure 1 according to a sixth embodiment of the present disclosure is different from the previous embodiments and variants in that the receiving section 113 defines a material receiving space 114. When a tool 20 is used to press against the second body portion 112, a partial material of the second body portion 112 is forced or flows into the material receiving space 114, so that the first body portion 111 and the second body portion 111 are connected by riveting and the stop section 122 of the floating section 12 is limited to a position between the first and the second body portion 111, 112. In this way, the first body portion 111 and the second body portion 112 are connected together through riveting and the floating section 12 can be movably limited to a position between the first and the second body portion 111, 112. Therefore, it is able to achieve the objective of moving the floating structure 1 more smoothly to abut it against an object and hold it in place on the object.

Please refer to FIG. 12. As shown, in addition to the above described first to sixth embodiments and the variants, there is a floating structure 1 according to a seventh embodiment of the present disclosure. The seventh embodiment is different from the previous embodiments and variants in that the second body portion 112 is an expansion connection section and is integrally formed with the first body portion 111 to facilitate easy pressing of a tool 20 against the second body portion 112, so that the second body portion 112 can be expanded toward the first body portion 111 and the stop section 122 of the floating section 12 can be limited to a position between the first body portion 111 and the expanded second body portion 112. In this way, the first body portion 111 and the second body portion 112 can be joined through expansion connection and the floating section 12 can be movably limited to a position between the first and the second body portion 111, 112. Therefore, it is able to achieve the objective of moving the floating structure 1 more smoothly to abut it against an object and hold it in place on the object.

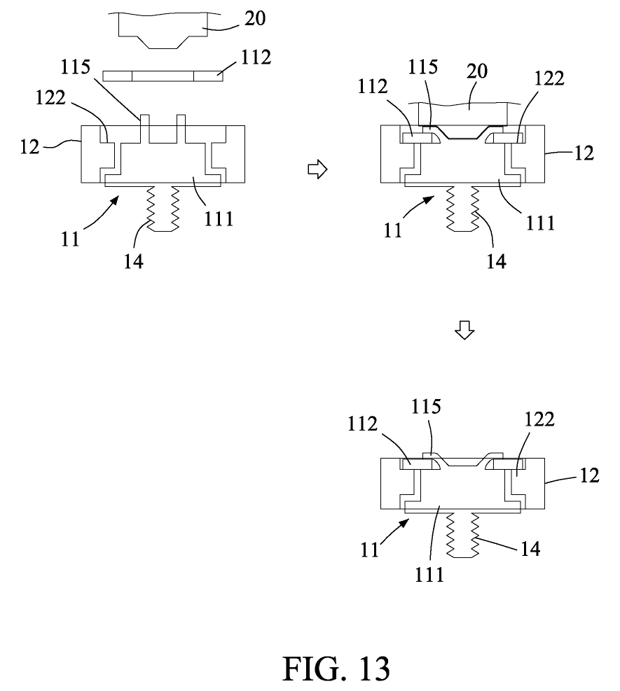

Please refer to FIG. 13. As shown, in addition to the above described first to seventh embodiments and the variants, there is a floating structure 1 according to an eighth embodiment of the present disclosure. The eighth embodiment is different from the previous embodiments and variants in that the first body portion 111 includes an expansion connection section 115. A tool 20 can be operated to press against the expansion connection section 115, so that the first and the second body portion 111, 112 can be joined through expansion of the expansion connection section 115 and the stop section 122 of the floating section 12 can be limited to a position between the first and the second body portion 111, 112. In this way, the first body portion 111 and the second body portion 112 can be joined through expansion connection and the floating section 12 can be movably limited to a position between the first and the second body portion 111, 112. Therefore, it is able to achieve the objective of moving the floating structure 1 more smoothly to abut it against an object and hold it in place on the object.

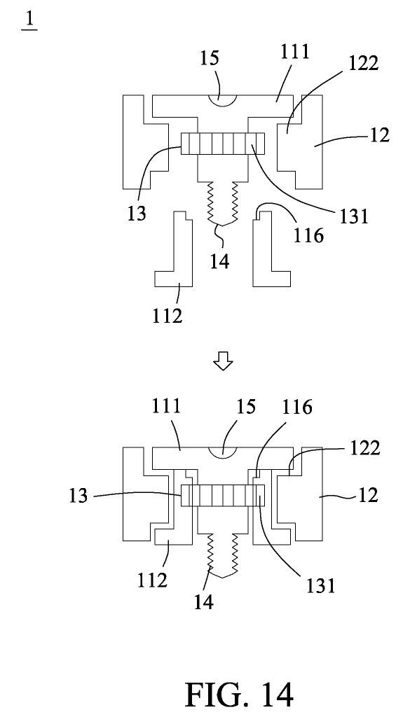

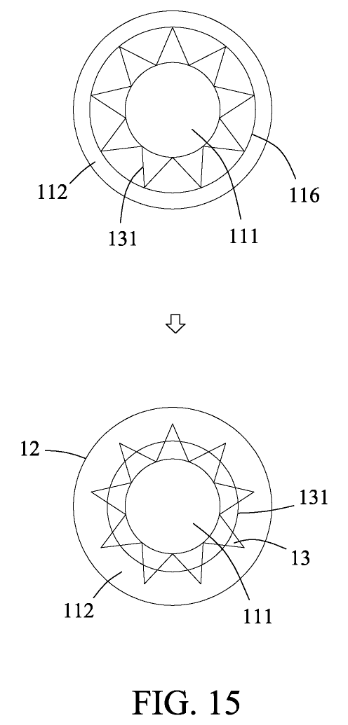

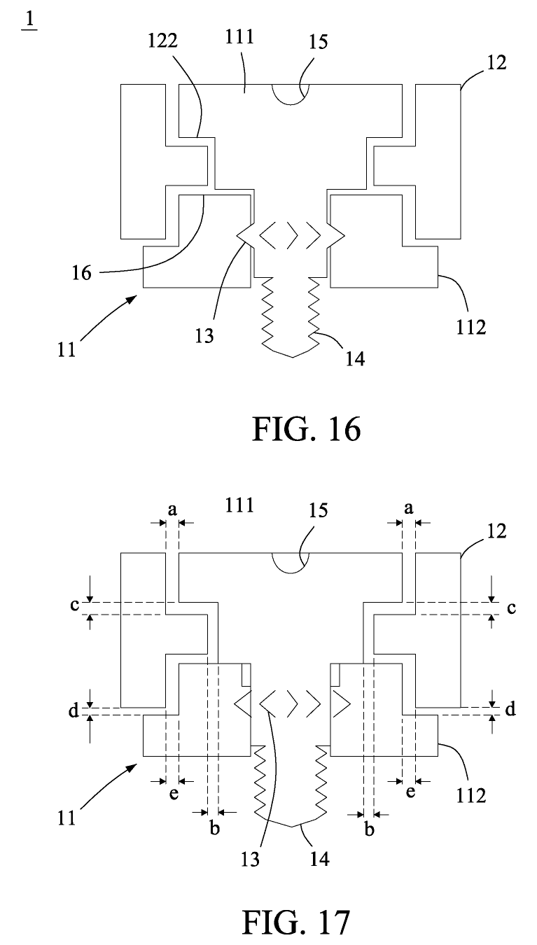

Please refer to FIGS. 14, 15, and 16. As shown, in addition to the above described first to eighth embodiments and the variants, there are floating structures 1 according to a ninth embodiment (see FIGS. 14 and 15) and a tenth embodiment (see FIG. 16) of the present disclosure. The ninth and the tenth embodiment are different from the previous embodiments and variants in that the second body portion 112 (or the first body portion 111) is provided with an alignment section 116, which is used for aligning or limiting the first body portion 111 to the second body portion 112 before assembling or riveting the second body portion 112 to the first body portion 111. In the ninth and the tenth embodiment, the coupling section 13 may be a toothed section or a clinching section. When the first body portion 111 and the second body portion 112 are assembled by way of clinching, a partial material of the first body portion 111 is forced or flows into clinching spaces 131 provided by the coupling section 13 to thereby connect the first body portion 111 to the second body portion 112. In the meantime, the stop section 121 of the floating section 12 is limited to a position between the first body portion 111 and the second body portion 112. In this way, the first body portion 111 and the second body portion 112 can be connected through riveting and the floating section 12 is movably limited to a position between the first and the second body portion 111, 112. Therefore, it is able to achieve the objective of moving the floating structure 1 more smoothly to abut it against an object and hold it in place on the object.

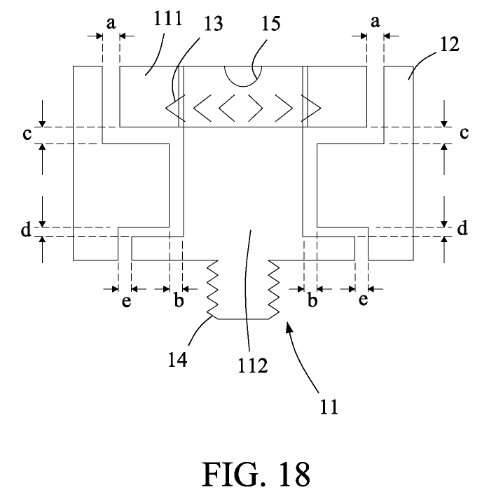

Please refer to FIGS. 17 and 18. As shown, in addition to the above described first to tenth embodiments and the variants, there are floating structures 1 according to an eleventh embodiment (see FIG. 17) and a twelfth embodiment (see FIG. 18) of the present disclosure. The eleventh and the twelfth embodiment are different from the previous embodiments and variants in that there is at least one longitudinal floating amount or transversely floating amount existed between the main body 11 and the floating section 12. In the illustrated eleventh and twelfth embodiments, a longitudinally extended first floating amount a is existed between the floating section 12 and the first body portion 111, a longitudinally extended second floating amount b is existed between the floating section 12 and the second body portion 112 or the first body portion 111, a transversely extended third floating amount c is existed between the floating section 12 and the first body portion 111, a transversely extended fourth floating amount d is existed between the floating section 12 and the second body portion 112, or a longitudinally extended fifth floating amount e is existed between the floating section 12 and the second body portion 112. With these arrangements, the floating section 12 can be stably but movably mounted on the main body 11. Therefore, it is able to achieve the objective of moving the floating structure 1 more smoothly to abut it against an object and hold it in place on the object.

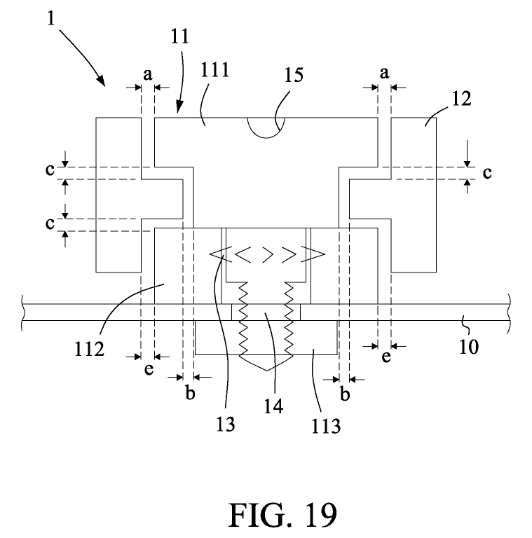

Please refer to FIG. 19. As shown, in addition to the above described first to twelfth embodiments and the variants, there is a floating structure 1 according to a thirteenth embodiment of the present disclosure. The thirteenth embodiment is different from the previous embodiments and variants in that the connection section 14 is provided on the first body portion 111 and is in the form of an externally threaded section; and the receiving section 113 is in the form of a nut. The connection section 14 can be extended through an object 10 to connect with the receiving section 113, such that the floating structure 1 is stably and securely connectable to the object 10.

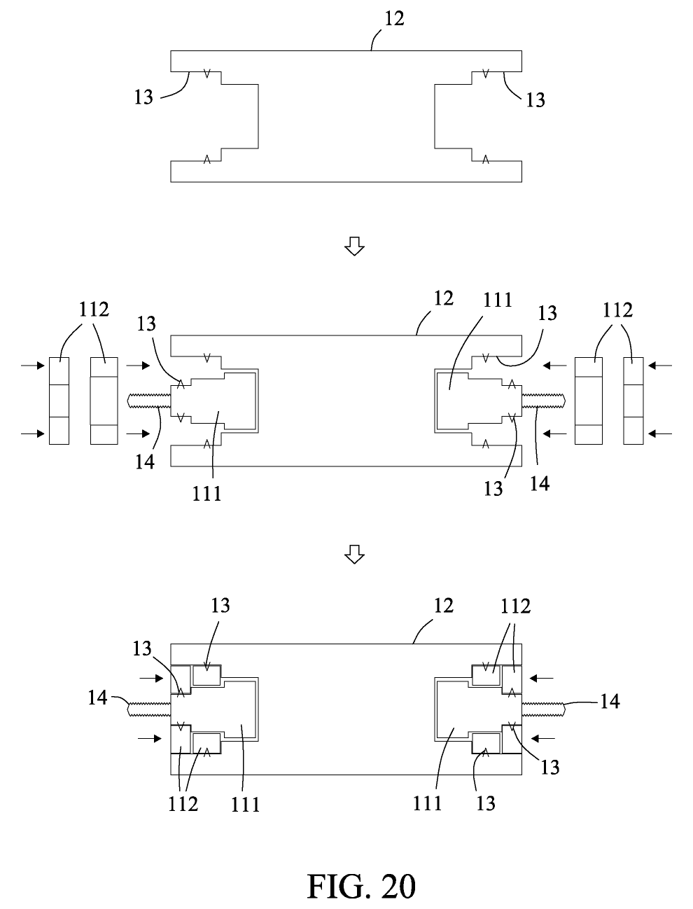

Please refer to FIG. 20. As shown, in addition to the above described first to thirteenth embodiments and the variants, there is a floating structure 1 according to a variant of the thirteenth embodiment of the present disclosure. The variant of the thirteenth embodiment is different from the thirteenth embodiment in that the coupling section 13 is provided on at least one end of the floating section 12. After the first body portion 111 is connected to the floating section 12, the second body portion 112 can be assembled to the coupling section 13 to thereby hold the first body portion 111 in place on the floating section 12. In this way, the floating section 12 can be stably but movably mounted on the main body 11. Therefore, it is able to achieve the objective of moving the floating structure 1 more smoothly to abut it against an object and hold it in place on the object.

In a further variant of the thirteenth embodiment, the floating structure 1 is different from the previous embodiments and variants in that, after the first body portion 111 is connected to the floating section 12 and the second body portion 112 is connected to the coupling section 13 on the floating section 12, another second body portion 112 is further connected to a coupling section 13 provided on the first body portion 111 to limit the first body portion 111 to between the floating section 12 and the two second body portions 112. In this way, the floating section 12 can be movably but stably mounted on the main body 11. Therefore, it is able to achieve the objective of moving the floating structure 1 more smoothly to abut it against an object and hold it in place on the object.

In addition to the above described embodiments and variants, a floating structure 1 according to an alternative embodiment of the present disclosure is different from the previous embodiments and variants in that a substance or an intermediate material capable of reducing frictional force is provided between the first body portion 111 and the second body portion 112 or the floating section 12; or alternatively, the substance or the intermediate material capable of reducing frictional force can be provided on the first body portion 111, the second body portion 112, or the floating section 12. The substance or the intermediate material capable of reducing frictional force can be grease, a Teflon layer, a liquid, a solid, or a coating. In this way, it is able to achieve the objective of moving the floating structure 1 more smoothly to abut it against an object and hold it in place on the object.

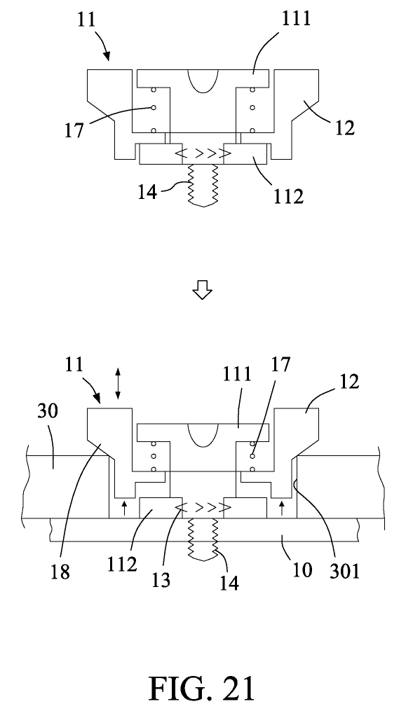

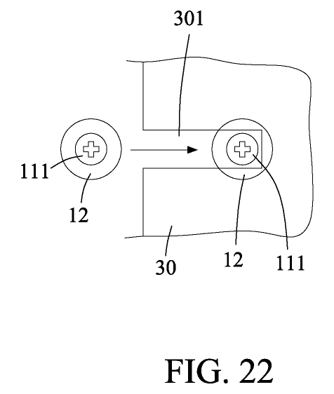

Please refer to FIGS. 21 and 22. As show, in addition to the above described first to thirteenth embodiments and variants, there is a floating structure 1 according to a fourteenth embodiment of the present disclosure. The fourteenth embodiment is different from the previous embodiment and variants in that, after the floating structure 1 is connected to an object 10 via the connection section 14, the floating section 12 can be transversely moved into a movement position 301 of another object 30 to thereby engage with the other object 30 or limit the other object 30 from moving. In this case, the floating section 12 also provides the function of connecting with the object 30.

In addition to the above described first to fourteenth embodiments and variants, there is a floating structure 1 according to a first variant of the fourteenth embodiment of the present disclosure. The first variant of the fourteenth embodiment is different from the previous embodiments and variants in that the floating structure 1 further includes an elastic element 17, which has an end pressed against the floating section 12 and another end pressed against the first or the second body portion 111, 112. With this arrangement, the floating section 12 can be elastically pushed by the elastic element 17 into the movement position 301 of the other object 30, so that the floating section 1 is engaged with, pressed against, elastically pushed against, or held to the other object 30. In this case, the floating section 12 is used as an engaging connection structure to achieve stable engagement with the other object 30.

In addition to the above described first to fourteenth embodiments and variants, there is a floating structure 1 according to a second variant of the fourteenth embodiment of the present disclosure. The second variant of the fourteenth embodiment is different from the previous embodiments and variants in that the floating section 12 includes an elevating section 18. The elevating section 18 can be a slant surface, and the other object 30 can be abutted against or moved upward along the slant surface of the elevating section 18. Therefore, when the floating section 12 is used as an engaging connection structure, it can stably engage with the movement position 301 of the other object 30.

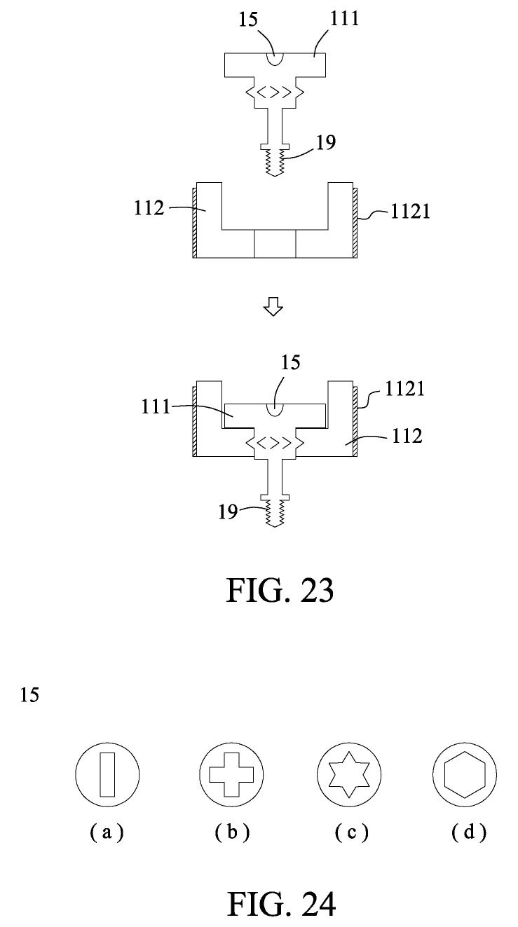

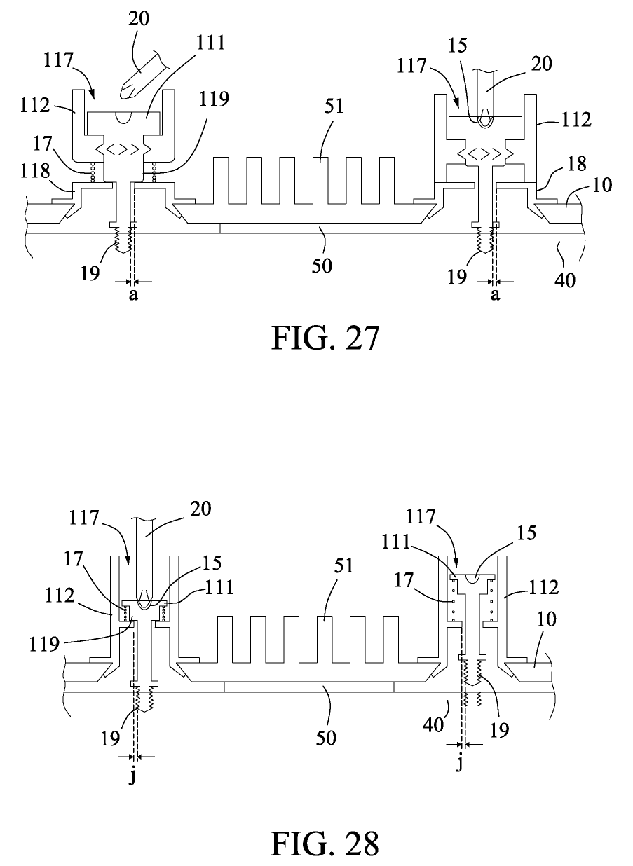

Please refer to FIGS. 23 and 25 to 28. As shown, in addition to the above described first to fourteenth embodiments and variants, there are floating structures 1 according to fifteenth to nineteenth embodiments of the present disclosure. The fifteenth to the nineteenth embodiment are different from the previous embodiments and variants in that the main body 11 consists of a first body portion 111, a second body portion 112, and a third body portion 118. The first body portion 111 includes a retaining section 19 and a handling section 15; and the second body portion 112 has a height larger than that of the first body portion 111 to form a protection zone 117. The second body portion 112 can limit, transversely block, stop, or embank a tool 20 being used to operate the handling section 15, and can prevent the tool 20 in operating the handling section 15 from being extended out of the protection zone 117 to undesirably collide with or damage any peripheral element. The peripheral element can be a chip 50 disposed on an object to be connected 40 (or another object), a heat sink 51, a printed circuit board, a connector, an optical fiber, a capacitor, a resistor, an electronic element, or an electrically conductive member. With these arrangements, the floating structure 1 of the present disclosure can better meet more requirements in practical applications thereof.

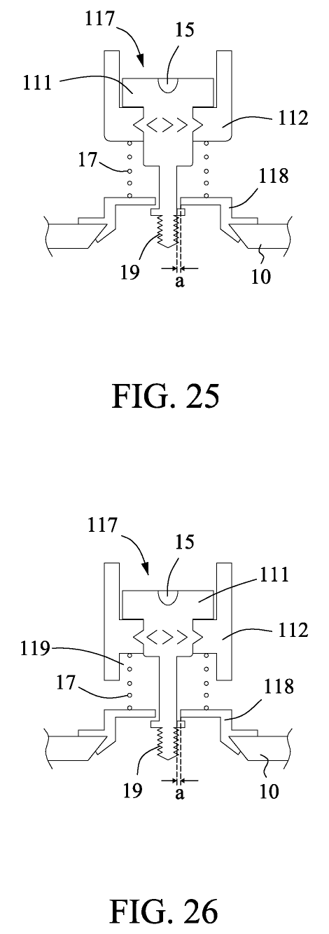

In the floating structure 1 according to the above fifteenth to nineteenth embodiments of the present disclosure, the third body portion 118 can be configured to serve as the floating section 12 of the previous embodiments, if necessary. And a floating amount is existed between the third body portion 118 (or the floating section 12) and the first body portion 111. In the sixteenth to the eighteenth embodiment shown in FIGS. 25 to 27, respectively, the floating amount is the above described first floating amount a existed between the floating section 12 and the first body portion 111. In this way, the third body portion 118 (or the floating section 12) can be moved more smoothly to abut against an object and be held in place on the object.

As shown, the floating structure 1 according to the nineteenth embodiment of the present disclosure is different from the eighteenth embodiment in that a tenth floating amount j is provided between the first body portion 111 and the second body portion 112. As shown in FIG. 28, the second body portion 112 in the nineteenth embodiment can be configured according to actual need to be the floating section 12 in the previous embodiments. In this way, the first body portion 111 can be moved more smoothly to abut against the object to be connected 40 and be held in place on the object to be connected 40.

In the floating structure 1 according to the present disclosure, the handling section 15 provided on the first body portion 111 can be differently designed. FIG. 24 illustrates some designs possible for the handling section 15. For example, the handling section 15 can be a straight line-shaped section, as shown in FIG. 24(a); or a cross-shaped section, as shown in FIG. 24(b); or a star-shaped section, as shown in FIG. 24(c); or a hexagon-shaped section, as shown in FIG. 24(d). The handling section 15 can be operated with a tool 20, and the tool 20 can be a screwdriver or a rotatable operating member. With these designs, the handling section 15 can better meet more requirements in practical applications of the floating structure 1.

The sixteenth to the nineteenth embodiment shown in FIGS. 25 to 28 are different from the previous embodiments and variants further in that an elastic element 17 is fitted between the first body portion 111, the second body portion 112, and the third body portion 118, and the third body portion 118 is used to connect with the object 10. Further, the first body portion 111, the second body portion 112, and the third body portion 118 can together define an accommodating space 119 for accommodating the elastic element 17 therein. With these arrangements, the main body 11 can be stably assembled to the object 10 via the third body portion 118. Meanwhile, a tool 20 may be used to operate the handling section 15 for the retaining section 19 to stably engage with the object to be connected 40.

The fifteenth to the nineteenth embodiment shown in FIGS. 23 to 28 are different from the previous embodiments and variants further in that the protection zone 117 serves to limit, stop, or embank the tool 20 when it is used to operate the handling section 15, lest the tool 20 should be extended to a position outside the protection zone 117 to undesirably collide with or damage any peripheral member. The protection zone 117 may be otherwise used to stop or limit the tool 20 from moving transversely. In this way, the floating structure 1 of the present disclosure can better meet more requirements in practical applications thereof.

The fifteenth to the nineteenth embodiment shown in FIGS. 23 to 28 are different from the previous embodiments and variants further in that a colored layer 1121 can be formed on the second body portion 112 by plastic injection molding, plastic insert molding, spray painting, baking finish, coating, or electroplating to allow for easy recognition of the second body portion 112 by color (as shown in FIG. 23). In this way, the second body portion 112 can better meet more requirements in practical applications of the floating structure 1.

In the fifteenth to the nineteenth embodiment shown in FIGS. 23 to 28, the second body portion 112 can be formed by plastic injection molding or plastic insert molding. The second body portion 112 formed by plastic injection molding or plastic insert molding can be then assembled to the first body portion 111. In this way, the second body portion 112 can better meet more requirements in practical applications of the floating structure 1.

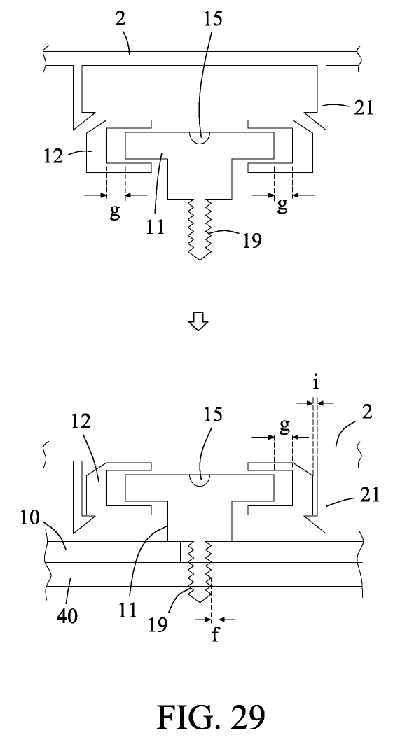

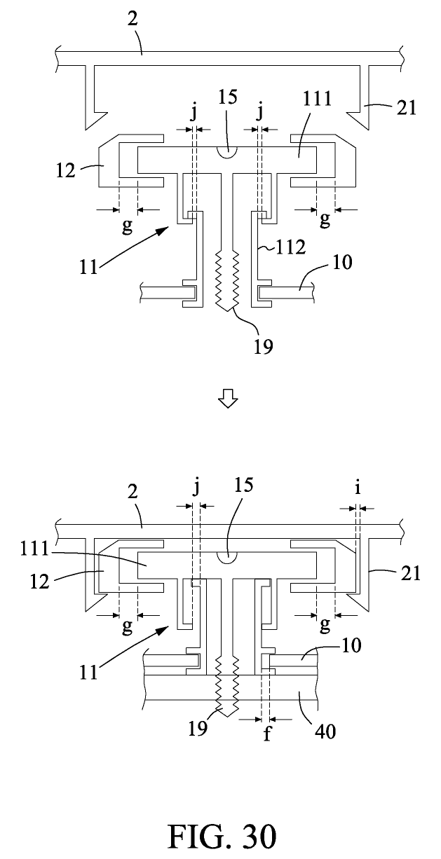

Please refer to FIGS. 29 to 31, in which a twentieth, a twenty-first, and a twenty-second embodiment of the present disclosure are shown, respectively; and to FIG. 32, in which different designs possible for the retaining section 19 of the floating structure 1 according to the present disclosure are shown. The twentieth to the twenty-second embodiment are different from the previous embodiments and variants in that there is a sixth floating amount f existed between the main body 11 and the object 10 and the body to be connected 40, and a seventh floating amount g existed between the main body 11 and the floating section 12 (see FIG. 29). The sixth or the seventh floating amount f, g is provided to allow for adjustment of the position of the floating section 12. Wherein, the sixth floating amount f may be located between the second body portion 112 of the main body 11 and the object 10 and the object to be connected 40, while the seventh floating amount g may be located between the first body portion 111 of the main body 11 and the floating section 12 (see FIG. 30). For example, the sixth floating amount f or the seventh floating amount g can be utilized to regulate or correct a position of the main body 11 and the floating section 12 relative to the object 10 and the object to be connected 40; or the sixth and the seventh floating amount can be regulated for the main body 11 and the floating section 12 to return to a centered position or a target position. In this way, the floating structure 1 of the present disclosure can better meet more requirements in practical applications thereof.

The floating structure 1 shown in FIGS. 29 and 30 are different from the previous embodiments and variants further in including a covering member 2 to be assembled to or snap-fitted onto the floating section 12. For this purpose, the covering member 2 includes an engagement section 21 for engaging with or snap-fitting onto the floating section 12. In this way, the floating structure 1 of the present disclosure can better meet more requirements in practical applications thereof.

The floating structures 1 shown in FIGS. 29 to 31 are different from the previous embodiments and variants further in that the main body 11 thereof is provided with a retaining section 19, which can be engaged with the object 10 or be extended through the object 10 to engage with the object to be connected 40. The retaining section 19 can be an externally threaded body, as shown in FIG. 32(a); an internally threaded body, as shown in FIG. 32(b); a column, as shown in FIG. 32(c); a male retainer, as shown in FIG. 32(d); a female retainer, as shown in FIG. 32(e); or an elastic snap fit joint, as shown in FIG. 32(f). In this way, the floating structure 1 of the present disclosure can better meet more requirements in practical applications thereof.

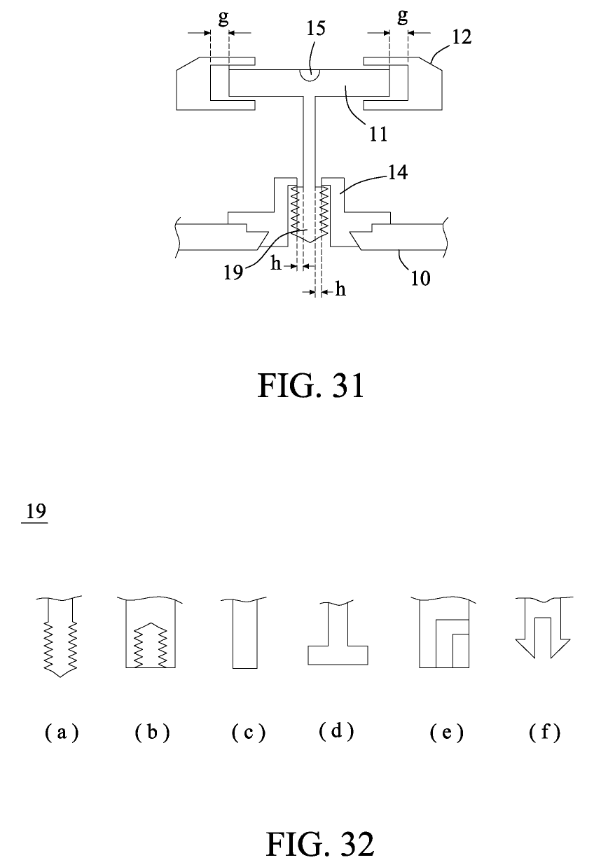

The floating structure 1 according to the twenty-second embodiment of the present invention as shown in FIG. 31 is different from the previous embodiments and variants in that the main body 11 is connected to a connection section 14; and an eighth floating amount h is existed between the main body 11 and the connection section 14. The floating structure 1 according to the twentieth and the twenty-first embodiment shown in FIGS. 29 and 30 are different from the previous embodiments and variants in that a ninth floating amount i is existed between the covering member 2 and the main body 11; and the floating section 12 can be handled to adjust the ninth floating amount i. In this way, the floating structure 1 of the present disclosure can better meet more requirements in practical applications thereof.

The floating structure 1 according to the twenty-first embodiment of the present disclosure as shown in FIG. 30 is different from the previous embodiments and variants in that a tenth floating amount j is existed between the first body portion 111 and the second body portion 112. With the tenth floating amount j, the first boy portion 111 and the second body portion 112 in use can be adjusted in position. In this way, the floating structure 1 of the present disclosure can better meet more requirements in practical applications thereof.

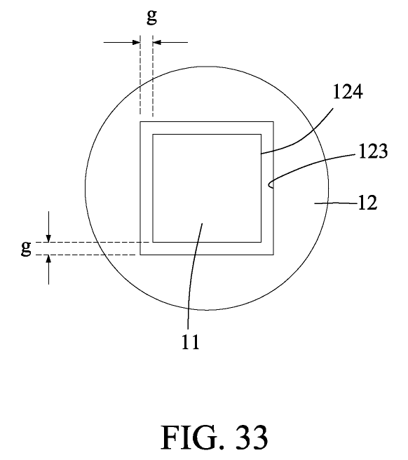

Please refer to FIG. 33. In addition to the above first to twenty-second embodiments and the variants of the present disclosure, there is a floating structure 1 according to a twenty-third embodiment of the present disclosure, as shown in FIG. 33. The twenty-third embodiment is different from the previous embodiments in that the floating section 12 includes an anti-rotation section 123 and the main body 11 includes a corresponding anti-rotation section124. The anti-rotation section 123 and the corresponding anti-rotation section 124 can engage with each other to prevent the main body 11 from rotating relative to the floating section 12. With this design, the floating structure 1 of the present disclosure can better meet more requirements in practical applications thereof.

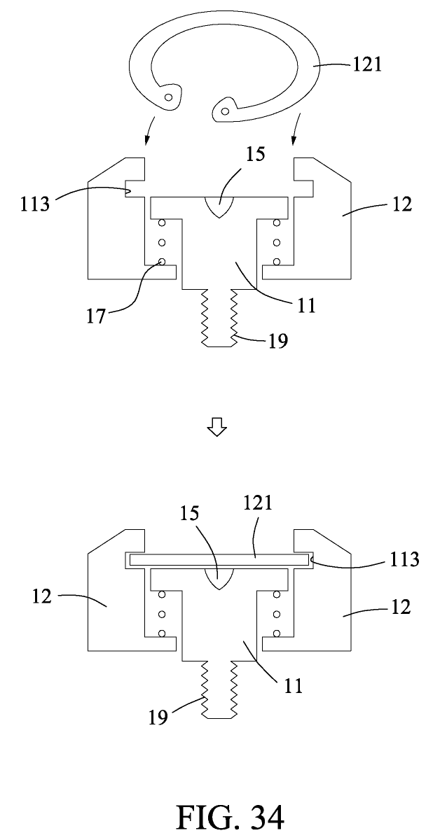

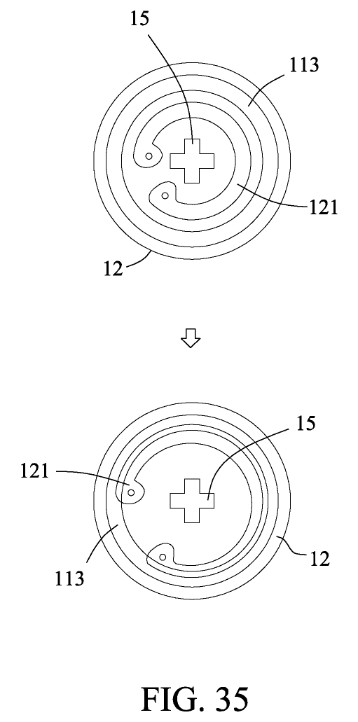

Please refer to FIGS. 34 and 35, in which a floating structure 1 according to a twenty-fourth embodiment of the present disclosure is shown. The twenty-fourth embodiment is different from the above first to twenty-third embodiments and variants in that the floating section 12 includes a receiving section 113, which can engage with a limiting section 121 to limit the main body 11 to the floating section 12. The limiting section 121 can be an element with elasticity to be elastically snap-fitted into the receiving section 113. An elastic element 17 is fitted around the main body 11 with two ends separately pressed against the main body 11 and the floating section 12, so that the floating section 12 is elastically floatable or correctable relative to the main body 11, preventing the floating section 12 from being located eccentrically or elastically floating eccentrically. With this design, the floating structure 1 of the present disclosure can better meet more requirements in practical applications thereof.

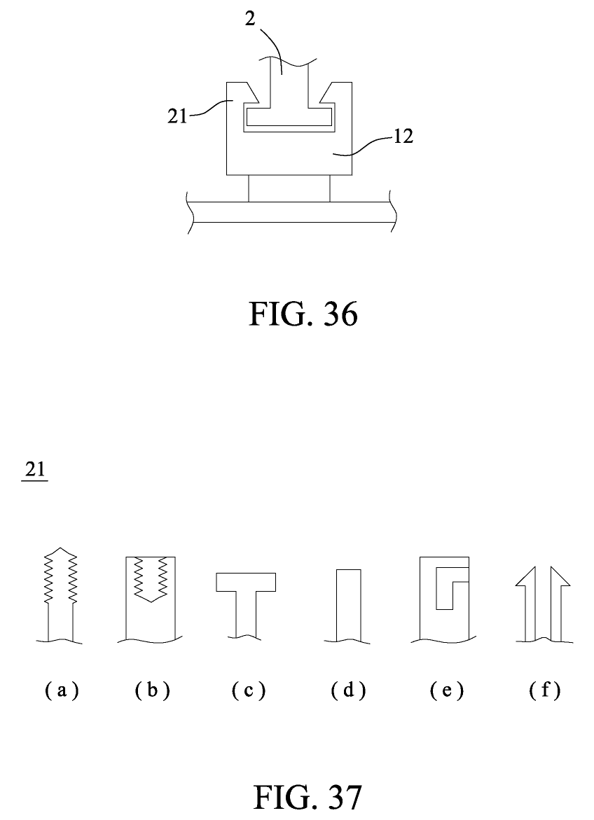

Please refer to FIGS. 36 and 37, in which a floating structure 1 according to a twenty-fifth embodiment of the present disclosure I shown. The twenty-fifth embodiment is different from the previous embodiments and variants in that the floating section 12 includes an engagement section 21 for engaging with a covering member 2. Alternatively, the engagement section 21 can be snap-fitted, locked, riveted, expansion connected, or welded to the covering member 2. The engagement section 21 can be an externally threaded section, as shown in FIG. 37(a); an internally threaded section, as shown in FIG. 37(b); a male retaining section, as shown in FIG. 37(c); a column, as shown in FIG. 37(d); a female retaining section, as shown in FIG. 37(e); an elastic snap fit joint, as shown in FIG. 37(f); or a female snap joint.

While the present invention has been described by means of specific embodiments, numerous modifications and variations could be made thereto by those skilled in the art without departing from the scope and spirit of the present invention set forth in the claims.

What is claimed is:

1. A floating structure, comprising:
a main body; and
a floating section mounted on the main body.

2. The floating structure according to claim 1, wherein the main body consists of a first body portion and a second body portion; or the first body portion and the second body portion being used to limit the floating section to a position; or one of the first and the second body portion being provided with an alignment section for aligning with or limiting the position of the other one of the first and the second body portion before the first and the second body portion are assembled or riveted to each other; or a longitudinally extended first floating amount being existed between the floating section and the first body portion, or a longitudinally extended second floating amount being existed between the floating section and the first or the second body portion, or a transversely extended third floating amount being existed between the floating section and the first body portion, or a transversely extended fourth floating amount being existed between the floating section and the second body portion, or a longitudinally extended fifth floating amount being existed between the floating section and the second body portion; or one of the first and the second body portion being provided with a coupling section, which is selected from the group consisting of a clinching section and a toothed section, such that the first body portion and the second body portion can be assembled by way of clinching, in which process a partial material of the first or the second body portion is forced or flows into a clinching space provided by the coupling section; or a longitudinal or a transverse floating amount being existed between the main body and the floating section.

3. The floating structure according to claim 1, wherein the main body consists of a first body portion and a second body portion; one of the first and the second body portion being provided with a coupling section, and the first and the second body portion being connected to each other via the coupling section while the floating section is limited to a position between the first and the second body portion; or the coupling section being selected from the group consisting of a riveting section, a protruded section, and a recessed section; or the first and the second body portion being connected to each other by way of riveting to limit the floating section to a position between them; or the floating structure further comprising an intermediate member, which is disposed between the main body and the floating section; or the floating structure further comprising an intermediate member disposed between the main body and the floating section to limit the floating section to a position; or one of the first and the second body portion being provided with a connection section; the connection section on the first or the second body portion being selected from the group consisting of an externally threaded section, an internally threaded section, a riveting section, an expansion connection section, a locking section, a welding section, a snap joint, and an elastic fastening section; or one of the first and the second body portion including a handling section used to assemble or lock the main body to an object; or the handling section being selected from the group consisting of a cross-shaped section, a straight line-shaped section, a hexagon-shaped section, a polygon-shaped section, a star-shaped section, a protruded section, and a recessed section; or the connection section being selected from the group consisting of an externally threaded section, an internally threaded section, a column, a riveting section, an expansion connection section, a welding section, an elastic fastening section, and a snap joint.

4. The floating structure according to claim 1, wherein the main body consists of a first body portion and a second body portion; or one of the first and the second body portion being provided with a coupling section, and the first and the second body portion being connected to each other via the coupling section while the floating section is limited to a position between the first and the second body portion; or the coupling section being selected from the group consisting of a riveting section, a protruded section, and a recessed section; or the first and the second body portion being connected to each other by way of riveting to limit the floating section to a position between them; or the floating structure further comprising an intermediate member, which is disposed between the main body and the floating section; or the floating structure further comprising an intermediate member disposed between the main body and the floating section for limiting the floating section to a position; or one of the first body portion and the second body portion being provided with a connection section; or the connection section on the first or the second body portion being selected from the group consisting of an externally threaded section, an internally threaded section, a riveting section, an expansion connection section, a locking section, a welding section, a snap joint, and an elastic fastening section; or one of the first and the second body portion including a handling section used to assemble or lock the main body to an object; or the handling section being selected from the group consisting of a cross-shaped section, a straight line-shaped section, a hexagon-shaped section, a polygon-shaped section, a star-shaped section, a protruded section, and a recessed section; or the connection section being selected from the group consisting of an externally threaded section, an internally threaded section, a column, a riveting section, an expansion connection section, a welding section, an elastic fastening section, and a snap joint.

5. The floating structure according to claim 1, wherein the main body consists of a first body portion and a second body portion; or one of the first body portion and the second body portion being provided with a connection section; or the connection section being extended through an object to connect to a receiving section; or the connection section being selected from the group consisting of an externally threaded section, a internally threaded section, a column, a riveting section, an expansion connection section, a welding section, an elastic fastening section, and a snap joint; or the floating section including a receiving section, which is used to receive a limiting section for limiting the main body to a position; or the limiting section being an elastic member to be elastically snap-fitted into the receiving section.

6. The floating structure according to claim 1, wherein the floating section is provided with a coupling section; a first body portion of the main body being connected to the floating section, a second body portion of the main body being then assembled to the coupling section on the floating section, or another second body portion being further connected to a coupling section provided on the first body portion, so as to limit the first body portion to a position; or the floating section being provided with a coupling section; a first body portion of the main body being connected to the floating section, a second body portion of the main body being further connected to the coupling section on the floating section to limit the first body portion to the floating section.

7. The floating structure according to claim 1, wherein the main body consists of a first body portion and a second body portion; a substance or an intermediate material capable of reducing frictional force being provided between the first body portion and the second body portion or the floating section; or the first body portion, the second body portion, or the floating section respectively being provided with a substance or an intermediate material capable of reducing frictional force; and the substance or the intermediate material capable of reducing frictional force being selected from the group consisting of grease, a Teflon layer, a liquid, a solid, and a coating.

8. The floating structure according to claim 1, wherein one of the main body and the floating section includes a connection section; or the connection section being locked, riveted, snap-fitted, expansion connected, or welded to at least one object; or the floating section being in a shape of a shaft or a column; or the connection section being selected from the group consisting of an externally threaded section, an internally threaded section, a column, a riveting section, an expansion connection section, a welding section, an elastic fastening section, and a snap-fit joint.

9. The floating structure according to claim 1, wherein the floating section is configured to be transversely movable into a movement position on another object, so as to engage with or limited the other object to a position; or the floating section including an elevating section for abutting against the other object or moving the other object upward; or the elevating section being a slant surface.

10. The floating structure according to claim 1, further comprising an elastic element, and wherein the main body consists of a first body portion and a second body portion; the elastic element having an end pressed against the floating section and another end pressed against one of the first and the second body portion; or wherein the floating structure further includes an elastic element and the main body consists of a first body portion and a second body portion; the elastic element having an end pressed against the floating section and another end pressed against one of the first and the second body portion, so that the floating body is elastically moved into another object to engage with, press against, or elastically push against the other object, or limit the other object to a position; or wherein the floating structure further includes an elastic element; the elastic element having two ends separately pressed against the main body and the floating section, so that the floating section is elastically floatable or correctable relative to the main body and prevented from being located eccentrically or elastically floating eccentrically.

11. The floating structure according to claim 1, wherein the main body consists of a first body portion and a second body portion; the first body portion including a retaining section or a handling section; the second body portion having a height larger than that of the first body portion to form a protection zone; or the floating section serving as a third body portion, or a floating amount being existed between the third body portion and the first body portion; or the main body being a first body portion provided with a retaining section or a handling section, or the floating section serving as a second body portion having a height larger than that of the first body portion to form a protection zone, or a floating amount being existed between the first body portion and the second body portion.

12. The floating structure according to claim 1, wherein the main body consists of a first body portion and a second body portion; the first body portion including a retaining section and a handling section; the second body portion having a height larger than that of the first body portion to form a protection zone; the second body portion being able to limit, transversely block, stop, or embank a tool operating or being used to operate the handling section or to prevent the tool in use or in operating the handling section from extending out of the protection zone to undesirably collide with or damage any peripheral element; the peripheral element being selected from the group consisting of as a chip, a printed circuit board, a connector, an optical fiber, a capacitor, a resistor, an electronic element, a heat sink, and an electrically conductive member; or the floating section serving as a second body portion, or a floating amount being existed between the first body portion and the second body portion; or the main body serving as a first body portion having a retaining section and a handling section, and the second body portion having a height larger than that of the first body portion to form a protection zone; the second body portion being able to limit, transversely block, stop, or embank a tool operating or being used to operate the handling section, or to prevent the tool in use or in operating the handling section from extending out of the protection zone to undesirably collide with or damage any peripheral element; or the peripheral element being selected from the group consisting of as a chip, a printed circuit board, a connector, an optical fiber, a capacitor, a resistor, an electronic element, a heat sink, and an electrically conductive member; or the floating section serving as a second body portion, or a floating amount being existed between the first body portion and the second body portion; or the handling section being selected from the group consisting of a straight line-shaped section, a cross-shaped section, a star-shaped section, and a hexagon-shaped section; or the handling section being able to be operated with a tool, or the tool being a screwdriver or a rotatable operating member; or the first body portion and the second body portion being movably assembled with a third body portion or an elastic element, and the third body portion being used to connect to an object to be connected; or the first body portion, the second body portion, or the third body portion being able to define an accommodation space for accommodating the elastic element therein.

13. The floating structure according to claim 1, wherein the main body consists of a first body portion and a second body portion; the second body portion being formed in a manner selected from the group consisting of plastic injection molding, plastic insert molding, spray painting, baking finish, coating, and electroplating, such that the second body portion includes a colored layer to allow for recognition of the second body portion by color; or the second body portion being formed by plastic injection molding or plastic insert molding, or the second body portion being formed by plastic injection molding or plastic insert molding to be coupled to or assembled with the first body portion.

14. The floating structure according to claim 1, wherein a sixth floating amount is existed between the main body and an object or an object to be connected, and a seventh floating amount is existed between the main body and the floating section, and the floating section being adjustable in position via the sixth or the seventh floating amount; or the main body being connectable to a connection section with an eighth floating amount existing between the main body and the connection section; or the floating structure further comprising a covering member, the covering member being connected to or engaged with the floating section; or the covering member including an engagement section, and the covering member being connected to or engaged with the floating section via the engagement section; or a ninth floating amount being existed between the covering member and the main body, and the floating section being usable to adjust the ninth floating amount; or the floating section including an engagement section, and the engagement section being used to engage with a covering member; or the engagement section being connectable with the covering member in a manner selected from the group consisting of snap-fitting, locking, riveting, expansion connection, and welding; or the engagement section being selected from the group consisting of an internally threaded section, an externally threaded section, a male retaining section, a female retaining section, a female snap joint, an elastic snap-fit joint, and a column.

15. The floating structure according to claim 1, wherein the main body includes a retaining section; the retaining section being used to engage with an object or being extendable through an object to engage with an object to be connected; or the retaining section being selected from the group consisting of an externally threaded section, an internally threaded section, a column, a male retaining section, a female retaining section, and an elastic snap joint; or the floating section including an anti-rotation section, and the anti-rotation section being used to prevent the main body from rotating relative to the floating section.

16. The floating structure according to claim 1, wherein the floating structure is selected from the group consisting of a wheel; a rotary member; a fastener; a fastener, a handle, and a puller mounted on a heat sink; a fastener mounted on a printed circuit board; a fastener mounted on a server or a computer; a fastener mounted on a metal member; a fastener mounted on a plastic member; a wheel mounted on a heat sink; a wheel mounted on a server or a computer; a wheel mounted on a printed circuit board; a wheel mounted on a metal member; a wheel mounted on a plastic member; a handle or a puller mounted on a heat sink; a handle or a puller mounted on a server or a computer; a handle or a puller mounted on a printed circuit board; a handle or a puller mounted on a metal member; and a handle or a puller mounted on a plastic member.
